(19) United States
(12) Patent Application Publication
(10) Pub. No.: US 2012/0080253 A1
(43) Pub. Date: Apr. 5, 2012

(54) FUEL-CELL-POWERED VEHICLE

(75) Inventors: Koji Katano, Toyota-shi (JP); Akira Aoto, Okazaki-shi (JP)

(73) Assignee: TOYOTA JIDOSHA KABUSHIKI KAISHA, Toyota-shi (JP)

(21) Appl. No.: 13/375,809

(22) PCT Filed: Apr. 12, 2010
(86) PCT No.: PCT/IB2010/000793

§ 371 Date: Dec. 2, 2011

(30) Foreign Application Priority Data
Jun. 4, 2009 (JP) 2009-135075

(51) Int. Cl. B60K 11/06

(52) U.S. Cl. 180/68.1

(57) ABSTRACT

A fuel-cell-powered vehicle includes a fuel cell, an air compressor that is mounted in an engine compartment of the vehicle and supplies air to the fuel cell, side members that are located on each lateral side of the engine compartment and fixed to a vehicle body, and a cross member that is laid so as to extend between the side members and supports the air compressor.

### BACKGROUND OF THE INVENTION

1. Field of the Invention

The invention relates to a fuel-cell-powered vehicle, and more particularly, to a fuel-cell-powered vehicle with an air compressor, provided in an engine compartment, for supplying air to the fuel cell.

2. Description of the Related Art

Conventionally vehicles are powered by internal combustion engines. In a vehicle such as a passenger vehicle or the like, the engine unit in which such an engine is integrated with a transmission is installed in an engine compartment (which is also called an engine room) located in the front portion of the vehicle.

The engine compartment is a space that is formed in a front portion of a vehicle body and is open on the lower side thereof (this space is closed on the upper side thereof by a hood). The engine unit arranged inside provided within the engine compartment is often attached onto so-called well-crib frame (which may also be called suspension members) via a support member that has a vibration damping function. The well-crib frame is designed as generally square frames in a vehicle lateral direction and laid so as to extend between cross members which are located on both sides of the engine compartment and fixed to the vehicle body.

The support member supports the weight of the engine unit from below, and hence needs to have a bending rigidity sufficient to endure the weight of the engine unit. In addition, a torsional moment as a reactive force of a torque output from the engine to an axle acts on the support member. Therefore, the support member must also exhibit a high rigidity against torsion to endure such a torsional moment. In order to ensure the required rigidity, the support member is often constructed as a high-strength, adamant metal frame. Thus, the support member is generally heavy and expensive.

On the other hand, in recent years, fuel-cell-powered vehicles that employ motors as motive power sources and that are equipped with fuel cells as electric power supply sources for the motors have been drawing attention. A fuel cell is a device that generates electric power through an electrochemical reaction between a fuel gas such as hydrogen or the like and oxygen in air. Unlike an engine, the fuel cell does not discharge carbon dioxide, which is a factor in global warming, and therefore is anticipated to be an environmentally friendly vehicular power supply device.

An air compressor mounted on the vehicle is sometimes actuated to draw in air from the atmosphere and supply the fuel cell with compressed air discharged from the air compressor. For example, Japanese Patent Application Publication No. 2008-215175 (JP-A-2008-215175) describes an air compressor integrated with an air-cooled intercooler. The air that has risen in temperature by being compressed and pressurized by the air compressor is appropriately cooled by the air-cooled intercooler before being supplied to the fuel cell.

In the above-described fuel-cell-powered vehicle, the fuel cell may be mounted underneath the floor of the vehicle, and a drive unit or a transaxle (TA) constructed by integrating, a motor, that serves as a motive power source, with a reducer may be mounted in the engine compartment. In this case, an air compressor is preferably mounted in the engine compartment without using the well-crib frame for the sake of a reduction in vehicle weight and a reduction in cost.

Further, in a compact vehicle mounted with an internal combustion engine with a relatively small displacement, with a view to reducing the weight of the vehicle from the standpoint of improving fuel consumption, an engine unit may be attached to an inner wall of an engine compartment of a vehicle body via the support member without using well-crib frame. Even if the vehicle having no well-crib frame is employed as a fuel-cell-powered vehicle, it is a problem how to mount the air compressor in the engine compartment.

### SUMMARY OF THE INVENTION

The invention provides a fuel-cell-powered vehicle that allows an air compressor to be mounted in an engine compartment with a lightweight, easy-to-manufacture, and inexpensive construction.

A fuel-cell-powered vehicle according to a first aspect of the invention includes a fuel cell, an air compressor that is mounted in an engine compartment of the vehicle and supplies air to the fuel cell, side members that are located on each lateral side of the engine compartment and fixed to a vehicle body, and a cross member that is laid so as to extend between the side members and supports the air compressor.

In the fuel-cell-powered vehicle according to the first aspect of the invention, the air compressor may be suspended from the cross member.

Further, in the above-described fuel-cell-powered vehicle, the air compressor may include a compression portion that compresses air drawn from an atmosphere through rotation of a compression member, a motor that has a rotational shaft coupled to the compression member and rotationally drives the compression member, and the air compressor may be arranged such that the rotational shaft extends along a vehicle longitudinal direction and the motor located in front of the compression portion.

Further, the above-described fuel-cell-powered vehicle may further include an air cleaner that is arranged on the cross member .to remove foreign matters contained in air drawn in from the atmosphere through actuation of the air compressor, and an intake pipe' that connects the air cleaner to an intake port, which is formed in a rear end face of the compression portion of the air compressor, and passes behind the cross member. In this case, the intake pipe may be provided above a drive shaft, which is coupled to front wheels, and overlaps with the drive shaft in the vehicle longitudinal direction.

Further, the above-described fuel-cell-powered vehicle may further include a rib member that extends in the vehicle lateral direction and that is fixed to a surface of the cross member, and an attachment member that is attached to the cross member at a position substantially corresponding to a center of a width of the rib member in the vehicle longitudinal direction to suspend the air compressor from the cross member.

Further, in the above-described fuel-cell-powered vehicle, the rib member may be fixed to an upper face of the cross member, and the air compressor may be attached near a lower face of the cross member.

In this case, the fuel-cell-powered vehicle may further include a terminal block that is provided on an outer peripheral face of a motor included in the air compressor. In addition, the terminal block may protrude in the vehicle lateral direction, or may protrude into an opening portion formed through the cross member.

Furthermore, in the above-described fuel-cell-powered vehicle, the air compressor may be a biaxial air compressor having two rotational compression members, and the biaxial air compressor may be provided adjacent to the drive unit, which includes a running motor, in the vehicle lateral direction in the engine compartment and inclined downward to the drive unit side.

The fuel-cell-powered vehicle according to the first aspect of the invention is constructed such that the cross member is provided to be laid so as to extend between the side members located on each lateral side of the engine compartment and fixed to the vehicle body, and that the air compressor is supported by the cross member. Thus, the air compressor can be mounted in the engine compartment without using the well-crib frame. Further, the flat cross member is easier to process, lower in manufacturing cost, and can be made lighter than the well-crib frame which is a high-strength frame. Then, the air compressor, which has been attached in advance to the cross member that can be made lighter in weight as described above, can be assembled with the vehicle body on a vehicle assembly line. As a result, the efficiency of assembling the vehicle is enhanced.

Furthermore, when the fuel-cell-powered vehicle according to the first aspect of the invention is designed such that the air compressor is suspended from the cross member, the air compressor can be mounted at a relatively low position in the engine compartment. Thus, the center of gravity of the vehicle is lowered, and the running stability of the vehicle is enhanced.

### BRIEF DESCRIPTION OF THE DRAWINGS

The features, advantages, and technical and industrial significance of this invention will be described in the following detailed description of an example embodiment of the invention with reference to the accompanying drawings, in which like numerals denote like elements, and wherein:

FIG. 1 is a schematic block diagram of a fuel-cell-powered vehicle according to the embodiment of the invention;

FIG. 2 shows the interior of an engine compartment in which the radiator has been removed, as viewed from the front of the vehicle;

FIG. 3 is a lateral cross-sectional view taken along a line 3A-3A in FIG. 2;

FIG. 4 is a partially enlarged view showing an air compressor that is attached to a cross member by an attachment member;

FIG. 5 is a lateral view from the direction of arrow B in FIG. 4;

FIG. 6 is a perspective view of a mounting member provided at a coupling portion of the air compressor to which the attachment member is coupled;

FIG. 7 shows the air compressor when attached near the lower face of the cross member with a motor terminal block protruding sideward;

FIG. 8 shows the air compressor when it is attached near the lower face of the cross member with the motor terminal block protruding upward;

FIG. 9 shows a lateral face of the cross member that its bent upward to position the cross member above the side members;

FIG. 10 shows a lateral face of the cross member that is bent downward to position the cross member below the side members; and

FIG. 11 is shows a biaxial air compressor that is attached to the cross member and inclined with respect to a horizontal direction.

### DETAILED DESCRIPTION OF EMBODIMENT

An embodiment of the invention will be described below in detail with reference to the accompanying drawings. The specific shapes, materials, numerical values, directions, and the like in this description are examples to facilitate description of the invention, and can be appropriately changed in accordance with use, purpose, specification, and the like.

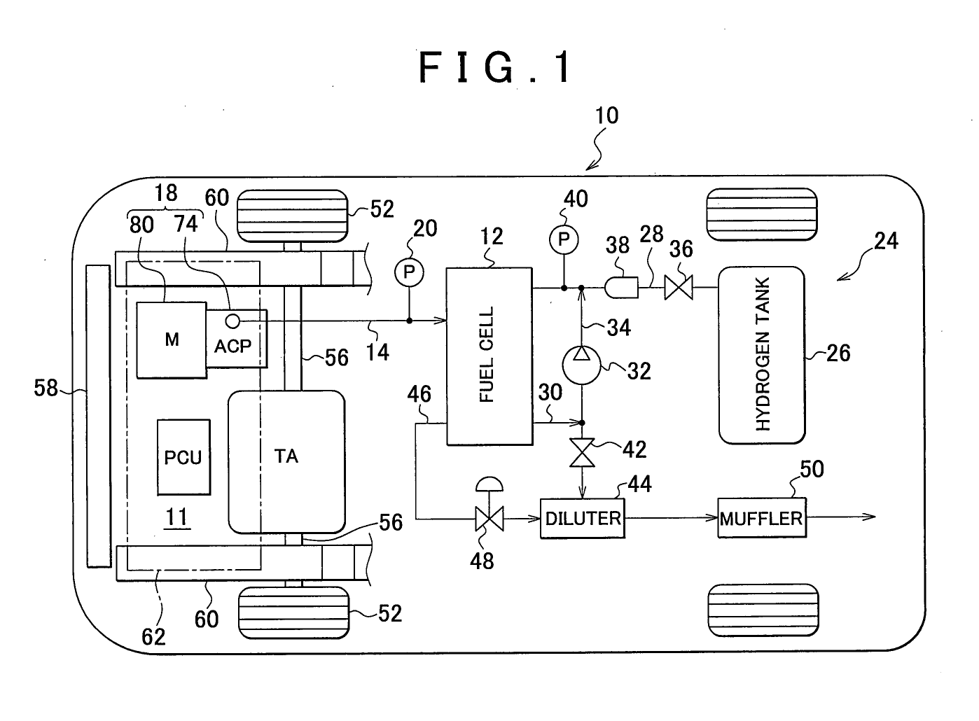

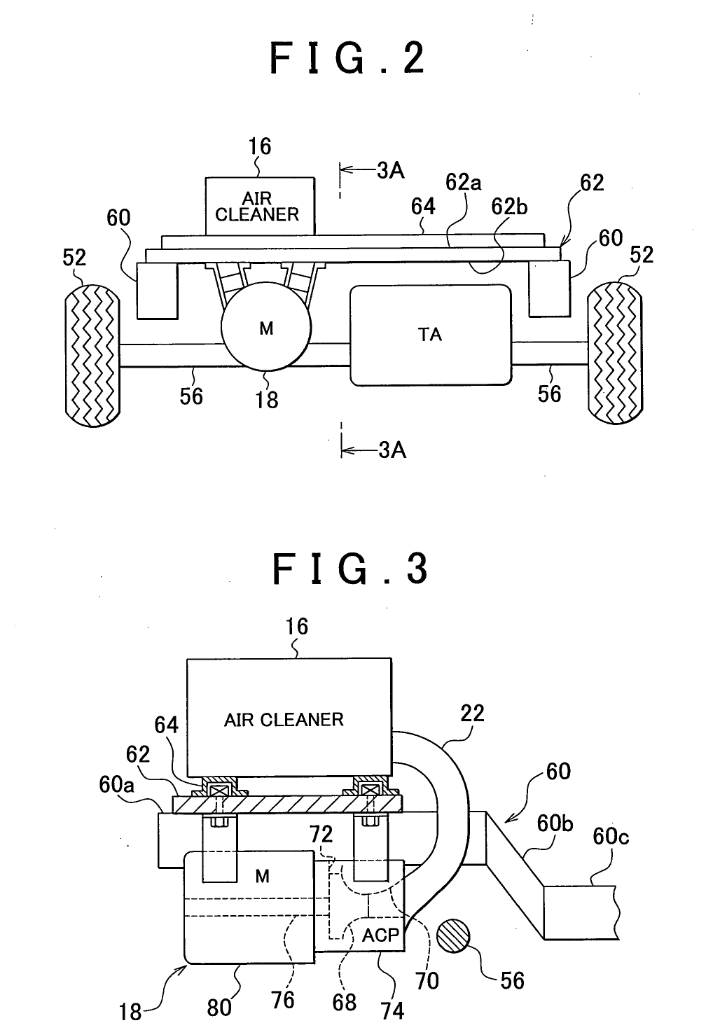

FIG. 1 is a schematic view of the configuration of a fuel-cell-powered vehicle 10 (hereinafter referred to simply as “the vehicle” when appropriate) according to the embodiment of the invention. In FIG. 1, the side of the vehicle 10 where a radiator 58 is installed (on the left side in FIG. 1) is shown as a front of the vehicle 10, and the opposite side of the vehicle 10 (on the right side in FIG. 1) is shown as a rear of the vehicle 10. Further, FIG. 2 shows the interior of an engine compartment 11, with the radiator 58 removed, as viewed from the front of the vehicle 10. FIG. 3 is a lateral cross-sectional view taken along a line 3A-3A in FIG. 2. The fuel-cell-powered vehicle 10 includes a fuel cell 12 that generates electric power to drive a motor that serves as the motive power source for the vehicle 10. The fuel cell 12 is mounted underneath the floor of the passenger compartment of the vehicle 10.

Alternatively, the fuel cell 12 may be mounted at a location other than underneath the floor, for example, at the rear or front of the vehicle body. Further, the fuel cell 12 may be accommodated in an airtight fuel cell case (not shown) when mounted on the vehicle 10.

The fuel cell 12 is supplied with hydrogen as a fuel gas and oxygen (air) as an oxidation gas to generate electric power. The fuel cell 12 is constructed as a cell stack as a lamination of a multitude of unit fuel cells that are electrically connected in series to one another. Each of the unit fuel cells is composed of a solid polymer electrolyte membrane, an anode (fuel electrode), a cathode (air electrode), and separators. The anode and the cathode are diffusion electrodes that sandwich the polymer electrolyte membrane to form a sandwich structure. The separators, which are made from conductive members impervious to gas, form hydrogen flow channels and air channels, composed of a plurality of recessed grooves, respectively between the anode and the cathode, while further sandwiching the sandwich structure.

The anode of each unit fuel cell includes a catalytic layer and a gas diffusion layer. The catalytic layer is primarily made of carbon powder carrying a metal catalyst of platinum group and contacts the solid polymer electrolyte membrane. The gas diffusion layer is formed on a surface of the catalytic layer, and is also permeable to air and electrically conductive. By the same token, the cathode includes a catalytic layer and a gas diffusion layer. For example, the catalytic layer may be formed by screen-printing on the polymer electrolyte membrane a paste prepared by adding an appropriate amount of an electrolyte solution to an appropriate organic solvent in which carbon powder carrying platinum or an platinum alloy. Further, the gas diffusion layer is formed of, for example, carbon cloth woven from threads made of carbon fiber, carbon paper, or carbon felt. The polymer electrolyte membrane is a proton conductive ion exchange membrane formed of a solid polymer material, for example, a fluorocarbon resin, that is electrically conductive favorably when moist.

In each unit fuel cell, hydrogen is supplied to the anode to undergo an oxidation reaction, expressed by H₂→2H⁺+2He⁻, and air is supplied to the cathode to undergo a reduction reaction, expressed by (½)O₂+2H⁺+2e⁻→H₂O. In the unit fuel cell as a whole, an electrochemical reaction expressed by H₂+(½)O₂→H₂O occurs. Electrons discharged from the hydrogen are then collected by the anode of each of the unit fuel cells and output from the fuel cell 12 as the generated electric power.

An air supply channel 14 is connected to the fuel cell 12. The air supply channel 14 is provided, sequentially from the upstream side with respect to the direction in which air is supplied to the fuel cell 12, with an air cleaner 16, an air compressor 18, and a pressure sensor 20. Air is drawn in from the atmosphere via the air cleaner 16 through the actuation of the air compressor 18. In passing through the air cleaner 16, foreign matters contained in air, such as dust and the like, are removed by a filter. The air that has passed the air cleaner 16 is introduced into the air compressor 18 via an intake pipe 22, compressed, discharged through a discharge port, and supplied to the fuel cell 12. The pressure of the air supplied to the fuel cell 12 is detected by the pressure sensor 20 and monitored by a controller (not shown).

A humidifier may be provided on the air supply channel 14 and designed to retrieve a portion of the produced water contained in the air discharged from the fuel cell 12, and may humidify the air supplied to the fuel cell 12 using the retrieved water.

Referring to FIG. 1, a hydrogen supply system 24 is connected to the fuel cell 12. The hydrogen supply system 24 includes a hydrogen supply source 26 such as, for example, a high-pressure hydrogen tank or the like, a hydrogen supply channel 28 through which hydrogen gas is supplied from the hydrogen supply source 26 to the fuel electrode of the fuel cell 12, a hydrogen discharge channel 30 through which hydrogen off gas from the fuel cell 12 discharged, and a circulation channel 34 for circulating the hydrogen off gas discharged to the hydrogen discharge channel 30 to the hydrogen supply channel 28 through the actuation of a circulation pump 32.

The hydrogen supply channel 28, which is connected to the fuel cell 12 from the hydrogen supply source 26, is provided, sequentially from the upstream side in a direction in which hydrogen gas is supplied, with a shutoff valve 36 that shuts off the outflow of hydrogen gas; from the hydrogen supply source 26, an injector 38 that appropriately reduces the pressure of the hydrogen gas spewing from the hydrogen supply source 26 and controls the amount of the hydrogen that is supplied, and a pressure sensor 40 that detects the pressure of the hydrogen gas supplied to the fuel cell 12. Further, the hydrogen discharge channel 30 is connected to a diluter 44 via a shutoff valve 42. A gas-liquid separator may be provided between the hydrogen discharge channel 30 and the circulation channel 34 to separate water, produced as a reaction by-product, from the hydrogen off gas and then feed the hydrogen off gas into the circulation channel 34.

An air discharge channel 46 is also connected to the fuel cell 12. Air used to generate electric power in each fuel cell 12 is discharged from the fuel cell 12 through the air discharge channel 46. The air discharge channel 46 is provided, sequentially from the upstream side with respect to the direction in which the air is discharged, with an air-pressure regulating valve 48, the diluter 44, and a muffler 50.

The diluter 44 mixes the hydrogen off gas introduced from the hydrogen discharge channel 30 when the shutoff valve 42 is opened with the air discharged from the fuel cell 12 to dilute the hydrogen off gas. The air pressure regulating valve 48 adjusts the opening degree of an included valve body in accordance with a command from the controller to control the flow rate and pressure of the air flowing through the air discharge channel 46, namely, the flow rate and pressure of the air supplied to the fuel cell 12. The muffler 50, which may be referred to as a silencer or a noise eliminator, reduces the amount of noise that is dissipated to the outside of the vehicle together with the air discharged from the upstream side.

The controller may be constructed as, for example, a microcomputer including a CPU, a RAM, a ROM, and the like. The controller controls the actuation of the shutoff valves 36 and 42, the actuation and opening degree of the injector 38 and the air pressure regulating valve 48, the actuation of the air compressor 18 and the circulation pump 32, and the like. The generation of electric power by the fuel cell 12 is thereby controlled.

A transaxle TA (a drive unit) integrally includes a motor that generates motive power for the fuel-cell-powered vehicle 10 (hereinafter referred to as “a driving motor”) and a reducer that reduces the rotational speed of the motor are mounted in the engine compartment 11 of the fuel-cell-powered vehicle 10. A three-phase synchronized alternating-current motor is preferably employed as the driving motor. The transaxle TA is attached to a wall of the engine compartment 11, which is a part of vehicle body, via a mount member (not shown) having a vibration damping function. Further, drive shafts 56 that transmits the driving force output from the driving motor to the front wheels 52 extends from each lateral face of the transaxle TA.

Further, an electric power control unit PCU is installed in the engine compartment 11. The electric power control unit PCU is electrically connected to the fuel cell 12 and the driving motor. The electric power control unit includes, for example, a boosting converter that boosts the voltage of the electric power supplied from the fuel cell 12 in a direct-current voltage, an inverter that converts the direct-current voltage output from the boosting converter into a three-phase alternating-current voltage, and the like. The alternating-current voltage output, from the inverter of the electric power control unit PCU is used to drive the driving motor. The actuation of the converter and the inverter is controlled in accordance with commands from the controller, which are generated in accordance with, for example, the operation of an accelerator. The torque and rotational speed of the driving motor are thereby controlled.

A radiator 58 is installed at the front-most portion of the engine compartment 11. The radiator 58 dissipates heat from coolant circulating via a circulation system (not shown) to cool the compressed air discharged from the air compressor 18, the electric power control unit PCU, and the like, due to a difference in temperature between the coolant and outside air, to thereby lower the temperatures of the compressed air, the electric power control unit PCU, and the like. In the fuel-cell-powered vehicle 10, the temperature of coolant does not increase as much as it would in a gasoline-powered vehicle. Therefore, the difference in temperature between coolant and outside air is small, and the efficiency of heat dissipation is not relatively good. As a result, the radiator 58 tends to be large.

Subsequently, the structure for supporting and attaching the air compressor 18 mounted in the engine compartment 11 will be described. A side member 60 is provided, respectively on each side of the engine compartment 11 in a vehicle lateral direction. The side members 60 may be formed as, for example, rectangular steel tubes or the like, and are fixed to the vehicle body.

A flat cross member 62 made of, for example, a rectangular metal plate is laid so as to extend between the side members 60 positioned at both lateral sides. The air compressor 18 is supported by the cross member 62. More specifically, the air compressor 18 is suspended from a lower face of the cross member 62. It should be noted in FIG. 1 that the cross member 62 is indicated by alternate long and short dash lines to clearly show the air compressor 18 arranged below the cross member 62 in a perspective state.

Each end of the cross member 62 is fixed to the corresponding side members 60 using appropriate fastening members such as bolts. Further, as shown in FIG. 3, the cross member 62 is fixed to the front end region 60a of each side member 60. The front end region 60a is located within the engine compartment 11. The front end region 60a is coupled to a region 60c located on a vehicle rear side via a coupling region 60b inclined upward toward the front portion of the vehicle. Thus, the front end region 60a of the side member 60 is provided parallel to a horizontal direction at a position slightly higher than a normal position of a side member, namely, a position close to a lowermost position of the vehicle body. This construction ensures sufficient space for mounting the air compressor below the cross member 62 to suspend the air compressor 18 from the lower face of the flat cross member 62 as described above.

Rib members 64 extending in the vehicle lateral direction are fixed to an upper face 62a of the cross member 62 according to an appropriate method such as welding or the like. The rib members 64 reinforce the flat cross member 62. It is preferable to provide a plurality of rib members 64 appropriately spaced apart in the vehicle longitudinal direction. In this embodiment of the invention, two rib members 64 are provided on a front part and a back part of the cross member 62. However, three or more rib members 64 may be provided, or only a single rib member 64 may be provided at a intermediate position in the vehicle longitudinal direction of the cross member 62. Further, the rib members 64 may not necessarily extend rectilinearly, but can be appropriately shaped so as to extend in a curved mariner m accordance with the shape of the cross member 62 where the rib member 64 is provided. The air cleaner 16 is arranged on and fixed to the rib members 64, but may be arranged on and fixed directly to the upper face 62a of the cross member 62.

It should be noted that the rib members 64 as reinforcing members for the cross member 62 may be fixed to the upper face 62a of the cross member 62 in this embodiment of the invention. However, the rib members 64 may alternatively be fixed to the lower face 62b of the cross member 62. Further, the rib members 64 may be omitted if the cross member 62 alone has sufficient strength to support the air compressor 18 and the air cleaner 16.

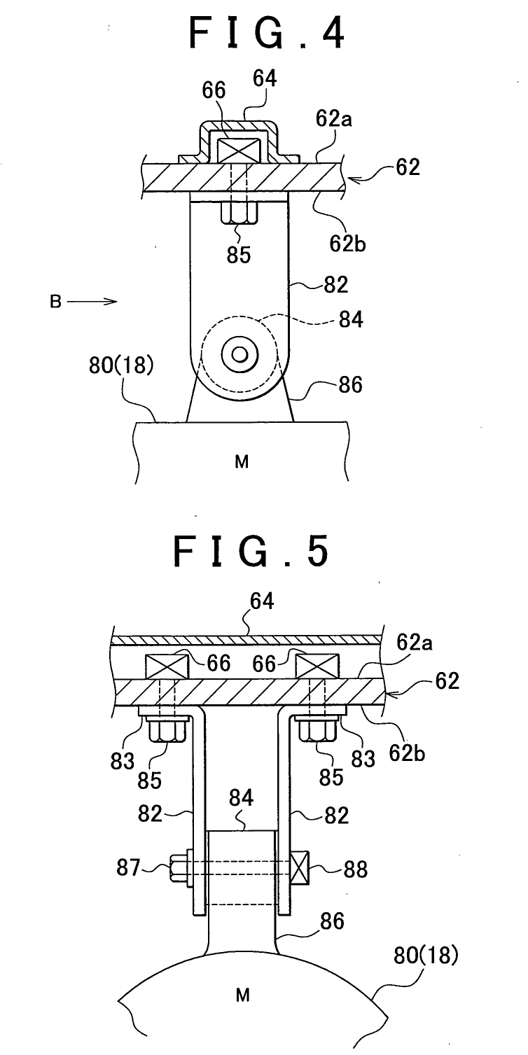

As shown in FIG. 3 and FIG. 4 as a partially enlarged view thereof, the rib member 64 is formed with a cross-sectional shape that allows the formation of an inner space that accommodates a nut 66 fixed to the upper face 62a of the cross member 62 by welding or the like, for example, with a transverse section in the shape of a top hat. Further, the rib members 64 are preferably made of a metal material in order to have an appropriate strength as the reinforcing members. For example, the rib members 64 may be formed by press-molding metal plates.

Referring to FIG. 3 again, the air compressor 18 is integrally equipped with a compression portion 74 (indicated by “ACP” in FIG. 3) that compresses the air drawn in from an intake port 70, formed through a rear end face, through the rotational driving of the compression member 68 incorporated in the air compressor 18 and discharges the compressed air from a discharge port 72 formed through an outer peripheral face, and a motor 80 (indicated by “M” in FIG. 3) whose rotational shaft 76 is coupled to the compression member 68. In addition, the air compressor 18 is arranged such that the rotational shaft 76 of the motor 80 extends along the vehicle longitudinal direction and that the motor 80 is located in front of the compression portion 74.

By thus arranging the air compressor 18, the intake pipe 22 extending from the air cleaner 16 can be connected with a shortest length behind the cross member 62 when being connected to the intake port 70 formed through the end face of the compression portion 74. In contrast, if the compression portion 74 is arranged in front of the motor 80 and the intake port is formed through a front end face, the intake pipe 22 may interfere with the radiator 58 and may not be attached with ease. However, this inconvenience may be avoided by arranging the compression portion 74 behind the motor 80.

Further, the intake pipe 22, which connects the air cleaner 16 to the air compressor 18, is preferably provided above the drive shaft 56 so as to overlap with the drive shaft 56 in the vehicle longitudinal direction, namely, so as to overlap with the drive shaft 56 when viewed from above the vehicle 10. In other words, the intake pipe 22, provided above the drive shaft 56, is preferably disposed at substantially the same position as the position at which the drive shaft 56 is disposed, in the longitudinal direction. By providing the intake pipe 22 at this position, the air compressor 18 and the intake pipe 22 may be compactly arranged in the vehicle length direction.

Furthermore, the intake port 70 provided through the end face of the compression portion 74 of the air compressor 18 is preferably formed close to an upper side of the end face of the compression portion, which assumes a generally circular shape. By thus forming the intake port 70, the intake pipe 22 is easily provided above the drive shaft 56 to overlap with the drive shaft 56 in the vehicle longitudinal direction even when the drive shaft 56 is arranged close to the intake pipe 22. As a result, the aforementioned compact arrangement can be realized easily.

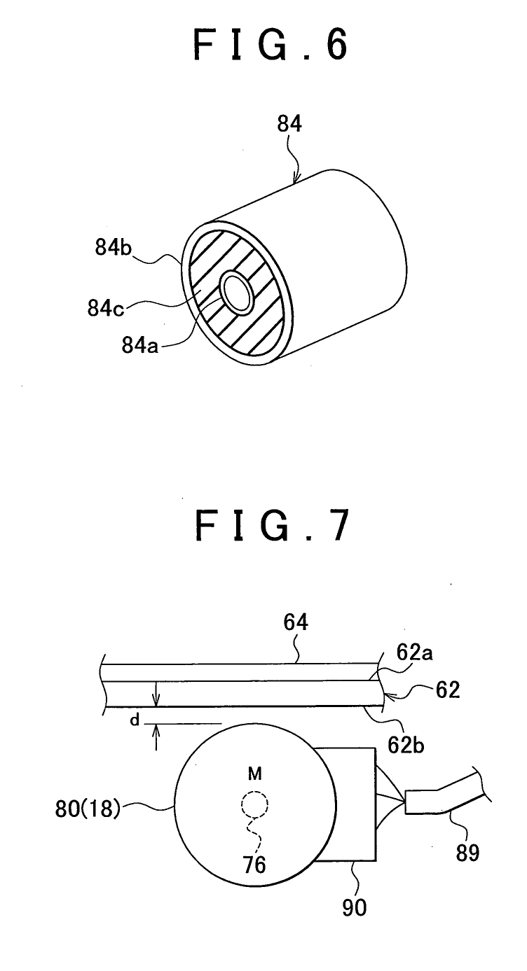

Next, with reference to FIGS. 4 to 6, the structure for attaching the air compressor 18 to the cross member 62 will be described in detail. FIG. 4 is a partially enlarged view showing the air compressor 18 attached to the lower face 62b of the cross member 62 by an attachment member 82. FIG. 5 is a lateral view from a direction of an arrow B in FIG. 4. Further, FIG. 6 is a perspective view of a mount member 84 provided at a coupling portion of the air compressor 18 to the attachment member 82.

The air compressor 18 is attached to the cross member 62 at four attachment locations. A pair of attachment members 82 and a mount member 84 fixed to the air compressor 18 are provided at each attachment location. Each of the attachment members 82 has an attachment portion 83 bent at an upper end thereof to extend along the horizontal direction. By fastening a bolt 85, which has been inserted through a through-hole formed through the attachment portion 83 and a through-hole formed through the cross member 62, into a nut 66 fixed to the upper face 62a of the cross member 62, the attachment member 82 is attached to the lower face 62b of the cross member 62.

It should be noted herein that the attachment member 82 is preferably attached to the cross member 62 (i.e., the nut 66 is preferably fixed) substantially at a position corresponding to the center of a width of a corresponding one of the rib members 64 in the vehicle longitudinal direction. If the attachment member 82 is attached to the cross member 62 at this position, the air compressor 18, which may weigh as much as about several tens of kilograms, can be supported at a position where the greatest reinforcing effect is achieved by the rib members 64. Accordingly, the thickness of the cross member 62 may be reduced and accordingly its weight may be reduced.

The mount member 84 provided at each of the attachment locations is fixed to the outer peripheral face of the air compressor 18, which generally assumes the shape of a circular cylinder, via an arm portion 86. As shown in FIG. 6, the mount member 84 is constructed by filling a space between two concentrically arranged metal tubes 84a and 84b with an elastic material 84c, such as rubber. Owing to this elastic material 84c, the mount member 84 has a vibration damping function.

At each of the attachment locations, with the mount member 84 inserted between lower ends of the pair of the attachment members 82, a bolt 87 is inserted through a through-hole formed through the lower end of each of the attachment members 82 and a central tube Ma of the mount member 84. A nut 88 is screwed in a falloff preventing manner onto an end of this bolt 87 to fix the mount member 84 to the attachment member 82. Thus, the air compressor 18 is attached to the cross member 62 via the attachment members 82 and the mount members 84.

Because the air compressor 18 is thus attached to the cross member 62 via the mount members 84, vibrations of the air compressor 18 are restrained from being transmitted to the cross member 62 due to a vibration absorbing action of the elastic member 84c included in each of the mount members 84. As a result, noise-vibration performance is improved. Further, because the pair of the attachment members 82 are provided at each of the attachment locations, the air compressor 18 is stably attached, and is resistant to the torsional force generated during the operation of the air compressor 18.

As described above, in this embodiment of the invention, the flat cross member 62 is laid so as to extend between the side members 60 located on each lateral side of the engine compartment 11 and fixed to the vehicle body, and the air compressor 18 is supported by the cross member 62. In the fuel-cell-powered vehicle 10 thus constructed, the air compressor 18 is mounted in the engine compartment 11 without using well-crib frame.

Further, the cross member 62 constructed as the flat metal plate is easier to process, lower in manufacturing cost, and can be made lighter in weight than a high-strength well-crib frame. Then, the lightweight cross member 62, to which the air compressor 18 has been attached in advance, may be assembled with the vehicle body on a vehicle assembly line. As a result, the efficiency of assembling the vehicle is enhanced.

Furthermore, the air compressor 18 is suspended from the cross member 62 and hence may be mounted at a relatively low position in the engine compartment 11. Thus, the center of gravity of the vehicle 10 is lowered, and the running stability of the vehicle 10 is enhanced.

Meanwhile, when the air compressor 18 is suspended from the cross member 62 as described above, a distance d between the lower face 62b of the cross member 62 and the air compressor 18 is preferably set short to arrange the air compressor 18 as close to the cross member 62 as possible, as shown in FIG. 7. Effective in this case is a method such as shortening the attachment members 82, shortening the arm portions 86 of the air compressor 18, directly fixing the mount members 84 onto the outer peripheral face of the air compressor 18, or the like. By thus arranging the air compressor 18 near the cross member 62, the height position of the air compressor 18 can be set low without changing the position where the air compressor 18 is mounted. Therefore, a large space can be ensured above the cross member 62. Thus, the capacity of the air cleaner 16 installed on the cross member 62 may be increased.

Further, as shown in FIG. 7, a terminal block 90 that is provided on the outer peripheral face of the motor 80 of the air compressor 18 and that is connected to power supply line 89 may protrude in vehicle lateral direction in arranging the air compressor 18 close to the cross member 62. Thus, interference between the terminal block 90 and the cross member 62 is suppressed.

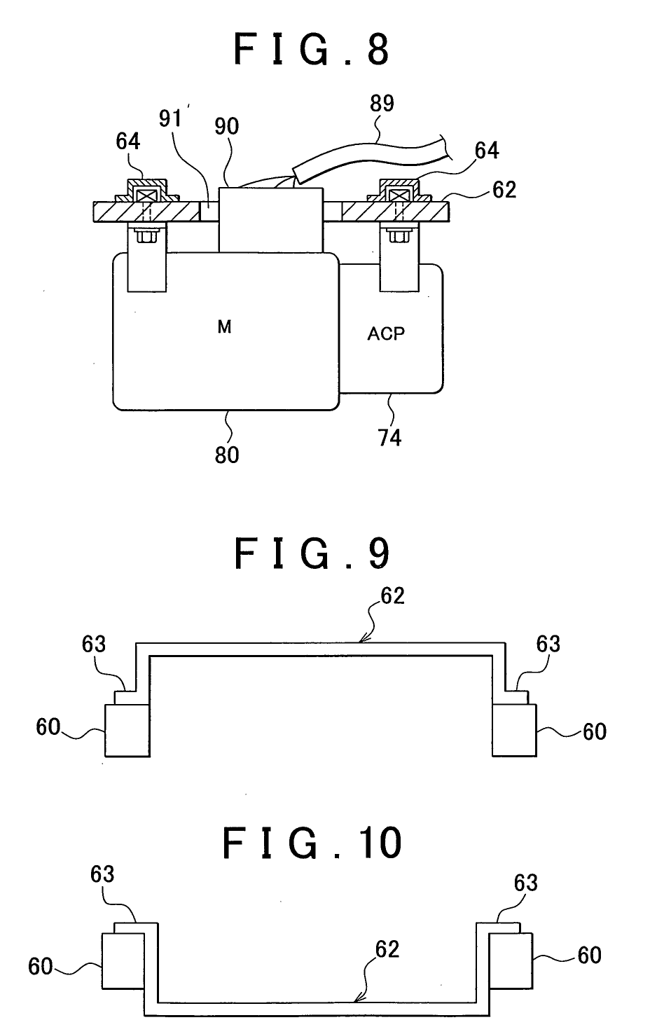

Alternatively, as shown in FIG. 8, an opening 91 may be formed though the region of the cross member 62 located between the rib members 64, and the terminal block 90 may protrude in vehicle upper direction so that the terminal block 90 is inserted into the opening 91. In this case as well, the location of the terminal block 90 does not interfere with the arrangement of the air compressor 18 near the cross member 62. Furthermore, the terminal block 90 thus protrudes upward is less likely to get wet from water that has entered the vehicle from below when the vehicle is traveling in rain or over a puddle. Even when the terminal block 90 protrudes sideways as shown in FIG. 7, a similar effect is achieved in comparison with a case where the terminal block 90 protrudes downward.

It should be noted that the foregoing description deals with the example in which the front end region 60a of each side member 60, which are located within the engine compartment 11, is set above the rear region 60c to increase the height of the flat plate-like cross member 62 (see FIG. 3). However, the fuel-cell-powered vehicle according to the invention is not restricted to this construction. For example, as shown in FIG. 9, the attachment regions 63 at each end of the cross member 62 may be bent downward to set the cross member 62 hi above the side members 60. In this manner, sufficient space for mounting the air compressor 18 below the cross member 62 may be provided, with the rectilinearly side members.

In contrast, as shown in FIG. 10, the attachment regions 63 at both the ends of the cross member 62 may be bent upward to set the cross member 62 below the side members 60. In this manner, the height of the cross member 62 may be reduced without changing the height of the side members 60 from the position shown in FIG. 3. As a result, the space above the cross member 62 as described with reference to FIGS. 7 and 8 may be increased.

Further, in the above embodiment of the invention, the air compressor 18 is suspended from the lower face 62b of the cross member 62. However, the fuel-cell-powered vehicle according to the invention is not restricted to this construction. The air compressor 18 may be laid on, attached to, and supported by the upper face 62a of the cross member 62.

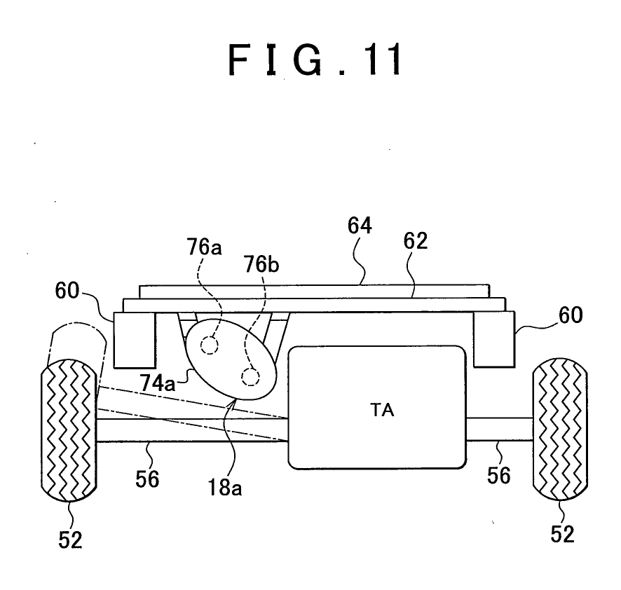

Next, a fuel-cell-powered vehicle equipped with a biaxial air compressor 18a will be described with reference to FIG. 11. Hereinafter, the same components as in the preceding embodiment of the invention are denoted using the same reference symbols respectively and will not be described again. Only those portions that differ from the above embodiment of the invention will be described.

FIG. 11 shows a view similar to that shown in FIG. 2, specifically, the biaxial air compressor 18a is inclined with respect to the horizontal direction. The biaxial air compressor 18a includes a compression portion 74a with two compression members that rotate respectively while correlating with each other, and includes two rotational shafts 76a and 76b that are attached to each compression member. A Roots-type air compressor is an example of a suitable biaxial air compressor 18a. The air compressor 18a has an end face that is shaped as an ellipse. The air compressor 18a may be mounted inclined with respect to the horizontal direction to be arranged between the transaxle TA adjacent thereto and the side members 60. In such a case, the air compressor 18a is preferably mounted at an incline so that the portion of the air compressor 18a located on the transaxle TA side is located below the portion of the air compressor 18a located on the side member 60 side.

By mounting the air compressor 18a at an incline, as described above, the air compressor 18a may be mounted near the drive shaft 56 on the transaxle TA side, where the moving amount of the drive shaft 56 in a vertical direction is smaller than on the front wheels 52 side as indicated by alternate long and short dash lines in FIG. 11. As a result, less space in the vertical direction is needed for accommodating the air compressor.

It should be noted that the biaxial air compressor may be attached to and supported by the adjacent transaxle TA via attachment members when being mounted at an incline. In this case, the biaxial air compressor is attached more stably when it is also suspended from the cross member 62.

1. A fuel-cell-powered vehicle comprising:
a fuel cell;
an air compressor that is mounted in an engine compartment of the vehicle and supplies air to the fuel cell;
side members that are located on each lateral side of the engine compartment and fixed to a vehicle body; and
a cross member that is laid so as to extend between the side members and supports the air compressor, wherein
the air compressor is suspended from the cross member.

2. (canceled)

3. The fuel-cell-powered vehicle according to claim 1, wherein
the air compressor comprises:
a compression portion that compresses air drawn in from an atmosphere through rotation of a compression member, and
a motor that has a rotational shaft coupled to the compression member and rotationally drives the compression member, wherein the air compressor is arranged such that the rotational shaft extends along a vehicle longitudinal direction and the motor is located in front of the compression portion.

4. The fuel-cell-powered vehicle according to claim 3, further comprising
an air cleaner that is arranged on the cross member to remove foreign matters contained in air drawn in from the atmosphere through actuation of the air compressor, and
an intake pipe that connects the air cleaner to an intake port, which is formed in a rear end face of the compression portion of the air compressor, and passes behind the cross member.

5. The fuel-cell-powered vehicle according to claim 4, wherein
the intake pipe is provided above a drive shaft, which is coupled to front wheels, and overlaps with the drive shaft in the vehicle longitudinal direction.

6. The fuel-cell-powered vehicle according to claim 1, further comprising
a rib member that extends in the vehicle lateral direction and that is fixed to a surface of the cross member, and
an attachment member that is attached to the cross member at a position substantially corresponding to a center of a width of the rib member in the vehicle longitudinal direction to suspend the air compressor from the cross member.

7. The fuel-cell-powered vehicle according to claim 6, wherein
the rib member is fixed to an upper face of the cross member, and
the air compressor is attached near a lower face of the cross member.

8. The fuel-cell-powered vehicle according to claim 7, further comprising
a terminal block that is provided on an outer peripheral face of a motor included in the air compressor and protrudes in the vehicle lateral direction.

9. The fuel-cell-powered vehicle according to claim 7, further comprising
a terminal block that is provided on an outer peripheral face of a motor included in the air compressor and protrudes into an opening portion formed through the cross member.

10. The fuel-cell-powered vehicle according to claim 1, wherein
the air compressor is a biaxial air compressor having two rotational compression members, and
the biaxial air compressor is provided adjacent to the drive unit, which includes a running motor, in the vehicle lateral direction in the engine compartment and inclined downward to the drive unit side.
